(19) United States
(12) Patent Application Publication
(10) Pub. No.: US 2023/0419930 A1
(43) Pub. Date: Dec. 28, 2023

(54) COMPUTING SYSTEM AND METHOD FOR MUSIC GENERATION

(71) Applicant: Lemon Inc., Grand Cayman (KY)

(72) Inventors: Yilin ZHANG, Los Angeles, CA (US); Andrew SHAW, Los Angeles, CA (US); Jitong CHEN, Los Angeles, CA (US)

(21) Appl. No.: 17/808,975

(22) Filed: Jun. 24, 2022

(51) Int. Cl. G10H 1/00

(52) U.S. Cl. CPC G10H 1/0025; G10H 1/0066; G10H 2240/141; G10H 2210/361; G10H 2210/576; G10H 2210/111; G10H 2210/151; G10H 2210/125; G10H 2210/031

(57) ABSTRACT

A music generation system is provided comprising a processor and a memory operatively coupled to the processor and storing a rhythm template database comprising a plurality of rhythm templates, and a music generation program stored in the memory and executed by the processor to be configured to receive a user input of lyrics, identify a plurality of syllables in the lyrics, determine a syllable pattern in the identified plurality of syllables, match the syllable pattern to a selected rhythm template of the plurality of rhythm templates, generate a melody based on the selected rhythm template, generate a music file encoding the melody and the lyrics, and output the music file encoding the melody and the lyrics.

### BACKGROUND

Programs have been developed that can generate music based on a lyric inputted by a user. However, the music that is generated by such programs often lacks musical qualities that many people appreciate, and thus isn't very song-like. For example, auto-generated music from such programs can suffer from misalignments in lyrics and melody notes, scattered or disjointed organization and song structure, mismatched rhythm tracks, and lack of a catchy repeating melody. As a result, such programs have not achieved widespread use. As a result, a barrier presently exists to rapid song development using such programs.

### SUMMARY

In view of the above, a music generation system is provided comprising a processor and a memory operatively coupled to the processor and storing a rhythm template database comprising a plurality of rhythm templates, and a music generation program stored in the memory and executed by the processor to be configured to receive a user input of lyrics, identify a plurality of syllables in the lyrics, determine a syllable pattern in the identified plurality of syllables, match the syllable pattern to a selected rhythm template of the plurality of rhythm templates, generate a melody based on the selected rhythm template, generate a music file encoding the melody and the lyrics, and output the music file encoding the melody and the lyrics.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a schematic view of a computing system according to an example of the present disclosure.

FIG. 2 illustrates a detailed schematic view of the song configuration file of FIG. 1.

FIG. 3 illustrates a detailed schematic view of the song structure settings of FIG. 1.

FIG. 4 illustrates a detailed schematic view of the score template of FIG. 1.

FIG. 5 is a flowchart of a method for generating music from an input of lyrics according to an example embodiment of the present disclosure.

FIG. 6 is a flowchart of a method for assigning rhythm templates to song sections and generating a song structure of rhythm repetitions according to an example embodiment of the present disclosure.

FIG. 7 is an illustration of the method assigning rhythm templates to song sections of FIG. 6.

FIG. 8 is an illustration of the method for rating rhythm templates for assigning rhythm templates to song sections of FIG. 6.

FIG. 9 shows an example computing environment of the present disclosure.

### DETAILED DESCRIPTION

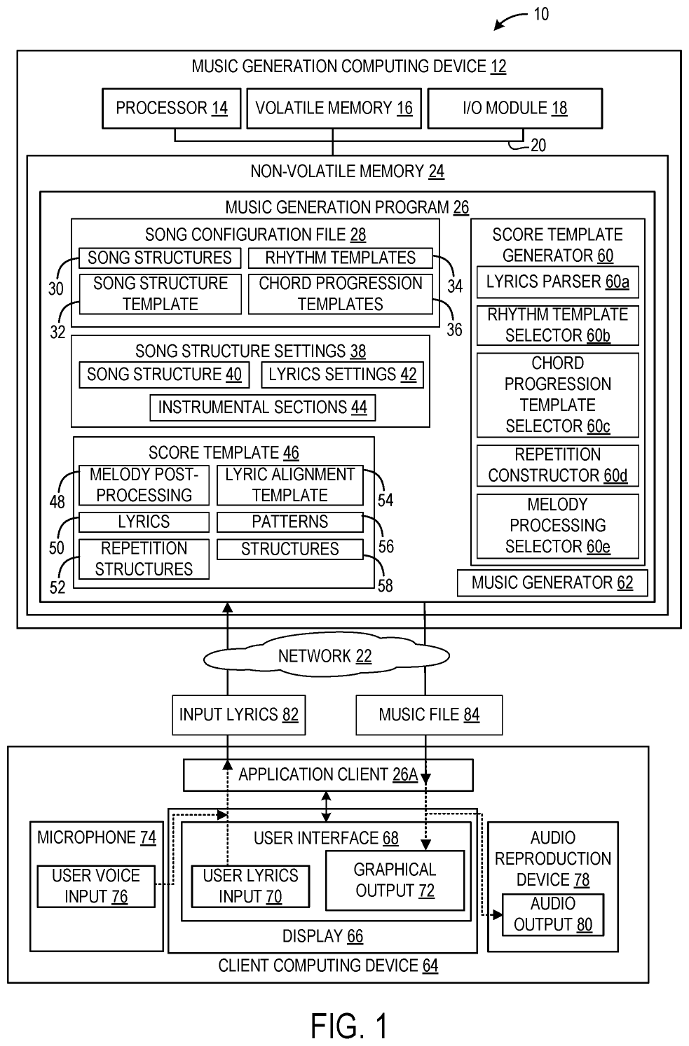

In view of the above issues, systems and methods are provided to generate music based on lyrics inputted by a user. Referring to FIG. 1, a music generation system 10 comprises a music generation computing device 12 including a processor 14, volatile memory 16, an input/output module 18, and non-volatile memory 24 storing a music generation program 26 including a song configuration file 28 comprising a plurality of rhythm templates 34, song structure settings 38, a score template 46, a score template generator 60, and a music generator 62. As used herein, the term score refers to a musical score.

A bus 20 may operatively couple the processor 14, the input/output module 18, and the volatile memory 16 to the non-volatile memory 24. Although the song configuration file 28, song structure settings 38, score template 46, the score template generator 60, and the music generator 62 are depicted as hosted (i.e., executed) at one computing device 12, it will be appreciated that the song configuration file 28, song structure settings 38, score template 46, score template generator 60, and music generator 62 can alternatively be hosted across a plurality of computing devices to which the computing device 12 is communicatively coupled via a network 22.

As one example of one such other computing device, a client computing device 64 may be provided, which is operatively coupled to the computing device 12. In some examples, the network 22 can take the form of a local area network (LAN), wide area network (WAN), wired network, wireless network, personal area network, or a combination thereof, and can include the Internet.

The computing device 12 comprises a processor 14 and a non-volatile memory 24 configured to store the song configuration file 28, song structure settings 38, score template 46, score template generator 60, and music generator 62 in non-volatile memory 16. Non-volatile memory 24 is memory that retains instructions stored data even in the absence of externally applied power, such as FLASH memory, a hard disk, read only memory (ROM), electrically erasable programmable memory (EEPROM), etc. The instructions include one or more programs, including the music generation program 26 comprising the score template generator 60, the music generator 62, and data used by such programs sufficient to perform the operations described herein. In response to execution by the processor 14, the instructions cause the processor 14 to execute the music generation program 26.

The processor 14 is a microprocessor that includes one or more of a central processing unit (CPU), a graphical processing unit (GPU), an application specific integrated circuit (ASIC), a system-on-chip (SOC), a field-programmable gate array (FPGA), a logic circuit, or other suitable type of microprocessor configured to perform the functions recited herein. The system 10 further includes volatile memory 16 such as random access memory (RAM), static random access memory (SRAM), dynamic random access memory (DRAM), etc., which temporarily stores data only for so long as power is applied during execution of programs.

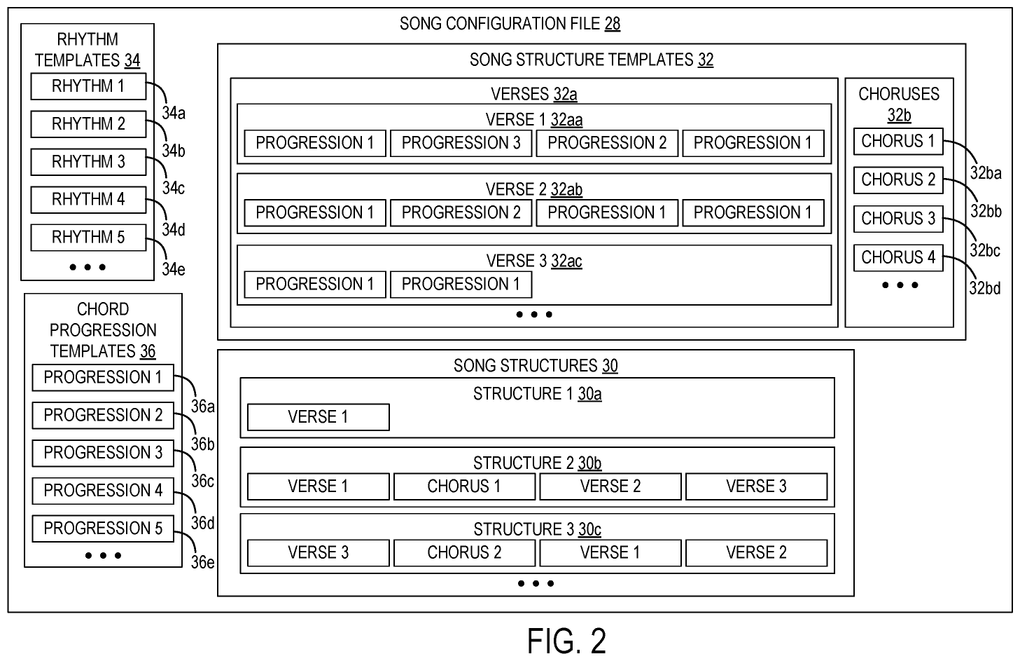

Referring to FIG. 2, an example of the song configuration file 28 accessed by the music generation program 26 to generate the outputted music file 84 is depicted. The song structures 30 include a first song structure 30a including a first verse, a second song structure 30b including a sequence of a first verse, a first chorus, a second verse, and a third verse, and a third song structure including a third verse, a second chorus, a first verse, and a second verse. The song structure templates 32 comprise verses 32a and choruses 32b. The verses 32a comprise a first verse 32aa specifying a sequence of chord progressions defined by the number sequence 1-3-2-1, a second verse 32ab specifying a sequence of chord progressions defined by the number sequence 1-2-1-1, and a third verse 32ac specifying a sequence of chord progressions defined by the number sequence 1-1. The choruses 32b comprise a first chorus 32ba, a second chorus 32bb, a third chorus 32bc, and a fourth chorus 32bd. The rhythm templates 34 comprise a first rhythm template 34a, a second rhythm template 34b, a third rhythm template 34c, a fourth rhythm template 34d, and a fifth rhythm template 34e. The chord progression templates 36 comprise a first chord progression template 36a, a second chord progression template 36b, a third chord progression template 36c, a fourth chord progression template 36d, and a fifth chord progression template 36e. It will be appreciated that the numbers of rhythm templates 34, chord progression templates 36, verses 32a, choruses 32b, and song structures 30 are not necessarily limited to the numbers described with reference to FIG. 2, and the numbers may be fewer or greater than the numbers depicted in FIG. 2.

Referring back to FIG. 1, when executed by the processor 14, the music generation program 26 is configured to receive a user input 82 of lyrics, identify a plurality of syllables in the set of lyrics, determine a syllable pattern 56 in the identified plurality of syllables, match a selected rhythm template of the plurality of rhythm templates 34 to the syllable pattern 56, generate a melody based on the selected rhythm template, generate a music file 84 encoding the melody and the lyrics, and output the music file 84 encoding the melody and the lyrics. Therefore, each of the plurality of song sections 50a-h is matched to one of the plurality of rhythm templates. The outputted music file 84 may be a melody score with lyrics, a MIDI file with chord progressions, or an audio file, for example. The outputted music file 84 may be outputted as graphical output 72 on a display 66 of the client computing device 64, or outputted as audio output 80 on an audio reproduction device 78 of the client computing device 64, for example. The audio reproduction device 78 may be a pair of speakers, for example. The user input 82 of lyrics may be inputted by user input 70 on a user interface 68 on the client computing device 64, or inputted by user voice input 76 on a microphone 74 of the client computing device 64, for example.

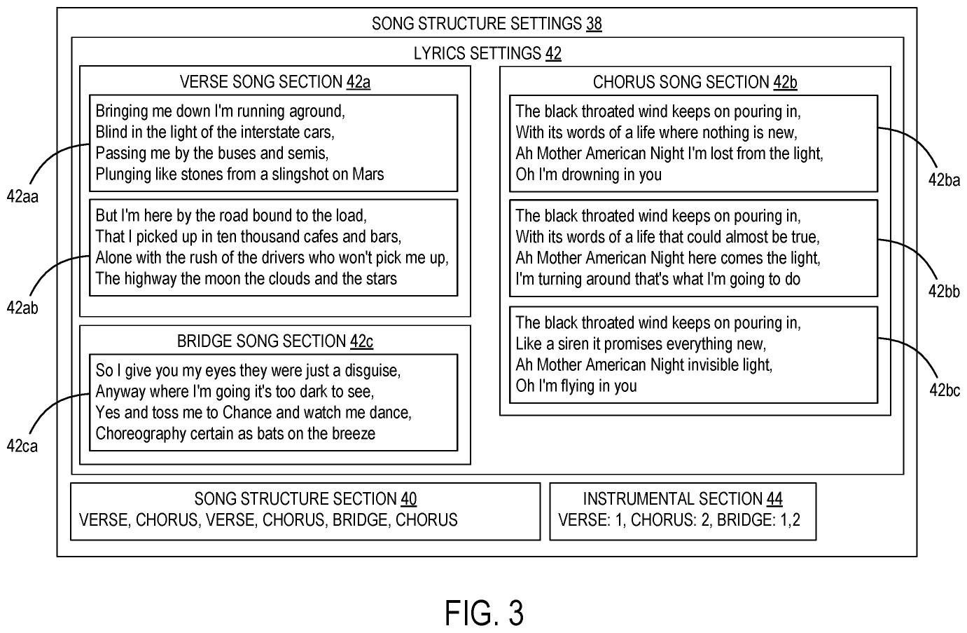

The user input 82 of lyrics may comprise song structure settings 38 or lyrics settings 42. Referring to FIGS. 1 and 3, song structure settings 38 may include lyrics settings 42, a song structure section 40 indicating an order of the plurality of song sections 50a-h, and instrumental section 44. The song structure section 40 and instrumental section 44 may be generated by the music generation program 26 or specified by the user input 82. The lyrics settings 42 comprises one or a plurality of song sections 42a-c each corresponding to one or more lyric paragraphs, or lists of lyric phrases or lyric strings. In the example of FIG. 3, the song sections 42a-c comprise a verse song section 42a, a chorus song section 42b, and a bridge song section 42c. Inside the verse song section 42a, there is a first verse lyric paragraph 42aa and a second verse lyric paragraph 42ab, each verse lyric paragraph representing a variation so that the first verse lyric paragraph 42aa and the second verse lyric paragraph 42ab have the same number of lyric phrases. Inside the chorus song section 42b, there is a first chorus lyric paragraph 42ba, a second chorus lyric paragraph 42bb, and a third chorus lyric paragraph 42bc, each chorus lyric paragraph representing a variation so that the first chorus lyric paragraph 42ba, the second chorus lyric paragraph 42bb, and the third chorus lyric paragraph 42bc have the same number of lyric phrases. Inside the bridge song section 42c, there is only one bridge lyric paragraph 42ca.

The order of variations may determine the actual order in which the variations appear in the final song. The number of variations may match the number of the appearance of the song section in the song structure section 40.

The instrumental section 44 specifies the instrumental music to accompany each song section within the song. In this example, the instrumental music is identified by a number representing a unique piece of instrumental music. The song structure section 40 specifies the actual structure of the song. In this example, the song structure section 40 comprises a sequence starting with a verse, followed up by a chorus, another verse, another chorus, a bridge, and ending with a third chorus.

Referring back to FIG. 1, the score template generator 60, which populates the score template 46 based on the user input 82 of lyrics, comprises a lyrics parser 60a, a rhythm template selector 60b, a chord progression template selector 60c, a repetition constructor 60d, and a melody processing selector 60e. The score template 46 specifies lyrics, all chord progressions, rhythms, and melody post-processing methods to use for a song. The score template 46 may be serialized into a json file.

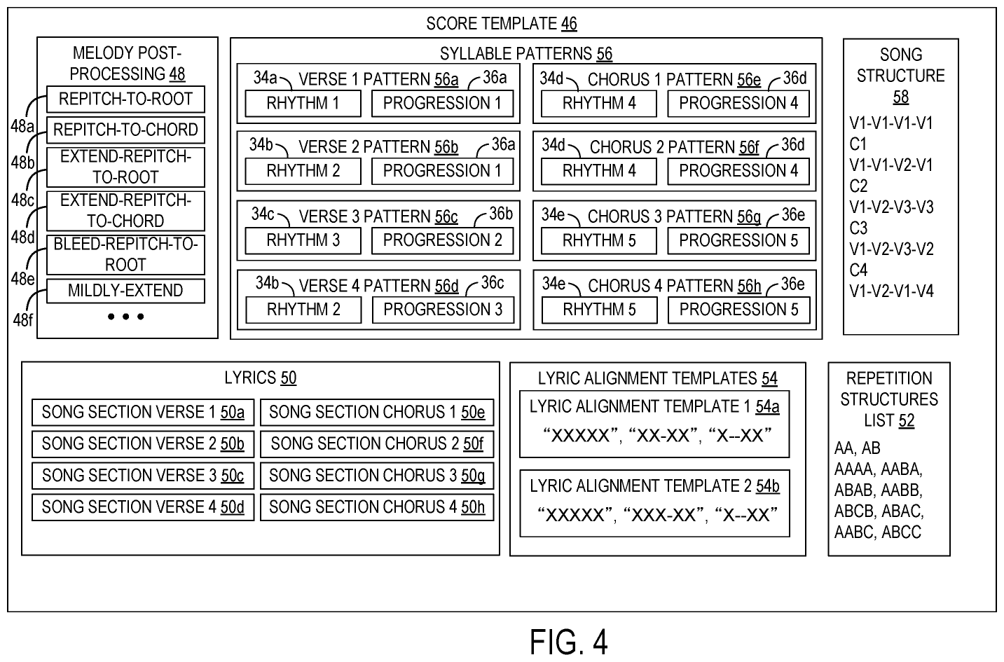

Referring to FIGS. 1 and 4, the score template 46 specifies the lyrics 50 and song sections 50a-h within the lyrics 50, in which the phonemes or syllables of each song section 50a-h are identified. In other words, the score template 46 specifies rhythm templates 34a-e and chord progression templates 36a-e which are assigned to each syllable pattern 56. The syllable patterns 56 may include verse patterns 56a-d and chorus patterns 56e-h corresponding to respective song sections 50a-h, also known as lyric paragraphs. Other syllable patterns 56 may include bridges, intros, and solos, for example, and may contain one or a plurality of lines of lyrics. The lyrics parser 60a parses the user input 82 of lyrics to obtain phonemes. A text-to-speech service may be called to obtain normalized lyrics with phonemes grouped by syllables. Each song section 50a-h may contain one or a plurality of lyric phrases, each lyric phrase representing one or a plurality of lines of lyrics.

For example, when Mandarin Chinese lyrics are processed by the lyrics parser 60a, Pinyin may be used as the phoneme format to obtain the phonemes. The phonemes may be grouped by syllables by identifying compound words in the lyrics. For example, in Mandarin Chinese lyrics, the lyrics “Jīntiān tiānqi zhēn h\check{a}d” are parsed into syllable groups “Jīntiān”, “tiānqi”, and “zhēn h\check{a}o”, so that there are three identified syllable groups, each having two syllables. In English lyrics, the lyrics “How are you today” are parsed into four syllable groups “How”, “are”, “you”, “today”, so that there are three identified syllable groups, each having one syllable, and one identified syllable group which has two syllables.

Responsive to parsing the lyrics, the rhythm template selector 60b is configured to assign a rhythm template to each song section of the lyrics, and the chord progression template selector 60c is configured to assign a chord progression template to each song section of the lyrics. Based on how the rhythm template selector 60b rates the rhythm template, the rhythm template selector 60b selects a rhythm template for each song section. Likewise, based on how the chord progression template selector 60c rates the chord progression template, the chord progression template selector 60c selects a chord progression template for each song section.

In the example of FIG. 4, a first rhythm template 34a and a first progression template 36a are assigned to a first verse pattern 56a which corresponds to a first song section 50a, which includes one or a plurality of lyric phrases. Although not shown in FIG. 4, a song section may be represented by a plurality of rhythm templates and/or a plurality of chord progression templates, so that each rhythm template—chord progression template pair corresponds to a lyric phrase of the song section 50a-h.

The rhythm template selector 60b may evaluate a first condition to ensure that the number of notes in the rhythm template is not equal to or smaller than the number of syllables in the syllable pattern of the song section. The rhythm template selector 60b may evaluate a second condition to ensure that the minimum number of syllables that the rhythm template supports is equal to or larger than the number of syllables in the song section. The rhythm template selector 60b may evaluate a third condition to ensure that there are no breaks inside a multi-syllabic English word (“hello”, for example) or a compound Chinese word (“n\check{i} h\check{a}d”, for example) when the rhythm template is matched to the song section. The rhythm template selector 60b may evaluate a fourth condition to determine how many words in the song section need to be deleted or added (for example, adding one word or deleting two words) to match the rhythm template to the song section.

For each song section, the rhythm template selector 60b of the music generation program 26 may rate the rhythm templates 34a-e based on how the first condition, second condition, the third condition, and/or the fourth condition are met by the rhythm template for the song section to determine a rating reflecting a degree of matching between the syllable pattern and each of the plurality of rhythm templates 34a-e. The rhythm template selector 60b selects a rhythm template 34a-e with the best rating for each song section.

The rhythm template selector 60b may use a lyrics alignment template 54 of the score template 46 to map a syllable sequence in the lyrics to a melodic and monophonic note sequence. The lyrics alignment template 54 supports the mapping of a certain range of syllables (10 to 15 syllables, for example). The lyrics alignment template 54 aligns syllables of the lyrics to a melodic and monophonic note sequence in the corresponding rhythm template 34. The lyrics alignment template 54 may be initialized manually, or generated automatically. The lyrics alignment template 54 may be provided in a format indicating how to map syllables to the notes. In the example of

FIG. 4, the first lyrics template 54a indicates “XXXXX”, “XX-XX”, “X—XX”, in which the ‘X’ letter instructs the system to map a syllable of the lyrics to the note, while the ‘-’ character instructs the system to not map a syllable of the lyrics to the note. The second line of the first lyrics template 54a, “XX-XX”, maps the first syllable to the first note, the second syllable to the second note, the third syllable to the fourth note, and the fourth syllable to the fifth note. When the final score is eventually parsed, the second syllable will cover two notes: the second note and the third note. In the second lyrics template 54b, the second line “XXX-XX”, maps the first syllable to the first note, the second syllable to the second note, the third syllable to the third note, the fourth syllable to the fifth note, and the fifth syllable to the sixth note.

Referring to FIG. 1, the repetition constructor 60d is configured to generate a song structure 58 based on the selected rhythm templates 34a-e and selected chord progressions templates 36a-e of the syllable patterns 56. The song structure 58 dictates how song section patterns 56a-h of the respective song sections 50a-h are sequenced or ordered in the final outputted music file 84. The song section patterns 56a-h are sorted and sequenced based on a repetition structures list 52 which specifies the allowed rhythm repetition types. For example, the ‘AAAA’ repetition type indicates that four verses with the same rhythm may be linked together, and the ‘ABAB’ repetition type indicates that two verses with two respectively different rhythms alternate in the sequence. Lyric phrases which share the same rhythm template and chord progression template may be configured to share the same pattern, so that the number of possible melody repetitions is maximized.

Referring to the example of FIG. 4, the generated song structure 58 comprises the first verse pattern 56a (V1) repeated four times (in accordance with the ‘AAAA’ repetition type), followed by the first chorus pattern 56e (C1), followed by a sequence of first verse pattern 56a (V1) to first verse pattern 56a (V1) to second verse pattern 56b (V2) to first verse pattern 56a (V1) (in accordance with the ‘AABA’ repetition type), followed by the second chorus pattern 56f (C2), followed by a sequence of first verse pattern 56a (V1) to second verse pattern 56b (V2) to third verse pattern 56c (V3) to third verse pattern 56c (V3) (in accordance with the ‘ABCC’ repetition type), followed by a third chorus pattern 56g (C3), followed by a sequence of first verse pattern 56a (V1) to second verse pattern 56b (V2) to third verse pattern 56c (V3) to second verse pattern 56b (V2) (in accordance with the ‘ABCB’ repetition type), followed by a fourth chorus pattern 56h (C4), followed by a sequence of first verse pattern 56a (V1) to second verse pattern 56b (V2) to first verse pattern 56a (V1) to fourth verse pattern 56d (V4) (in accordance with the ‘ABAC’ repetition type). As described in more detail below with reference to FIG. 8, the linking of verses may be regulated by a prescribed list of rhythm pairs that are prohibited from being linked with each other. For example, if the prescribed list of prohibited rhythm pairs includes a second rhythm template 34b—third rhythm template 34c pair, then the third verse pattern 56c containing the third rhythm template 34c and the fourth verse pattern 56d containing the second rhythm template 34b may be prohibited from being sequenced together in the generated song structure 58.

It will be appreciated that the numbers of post-processing methods in the melody post-processing template 48, syllable patterns 56, song sections 50a-h, lyric alignment templates 54, repetition types in the repetition structures list 52 are not necessarily limited to the numbers described with reference to FIG. 4, and the numbers may be fewer or greater than the numbers depicted in FIG. 4.

Referring to FIG. 1, the melody processing selector 60e selects melody post-processing steps which are performed after the song structure 58 is generated and before music file 84 is generated. Melody post-processing may increase melody quality. The selection of post-processing steps may be performed by a rules-based algorithm, or performed by the user. Referring to the example of FIG. 4, the score template 46 may include a melody post-processing template 48 which prescribes post-processing methods implemented to process the last note in a syllable pattern 56. These post-processing methods may include a repitch-to-root process 48a of changing the pitch to the nearest root note of the current chord, a repitch-to-chord process 48b of changing the pitch to the nearest chord note of the current chord, an extend-repitch-to-root process 48c of extending the offset of the note to as far as it can reach before the pattern's end and changing the pitch to the nearest root note of the current chord, an extend-repitch-to-chord process 48d of extending the offset of the note to as far as it can reach before the pattern's end and changing the pitch to the nearest chord note of the current chord, a bleed-repitch-to-root process 48e of extending the offset of the note to as far as it can reach before the next pattern's second beat and changing the pitch to the nearest root note of the current chord, and/or a mildly-extend process 48f of mildly extending the last note's duration to a quarter note (1 beat) to avoid an abrupt stop, which might lead to a duration bleed. The last post-processing method may be set as the default post-processing method applied to every lyric phrase to compensate for defective or idiosyncratic rhythm template designs that may cause an abrupt stop in the singing voice.

The populated score template 46 is then inputted into the music generator 62 to generate a music file 84 encoding the melody and the lyrics, applying the melody post-processing methods selected by the melody processing selector 60e. The melody post-processing methods may be performed by a pitch generator, which may be a conditional multimodal variational autoencoder (MVAE) model, for example.

For each song section, the music generator 62 may select and stitch all the syllable patterns 56 in the score template 46 to generate a melody score with lyrics, a MIDI file with chord progressions, or an audio file, for example. The length of the music file 84 may depend on the pattern lengths and the number of unique patterns for each song section. For example, if a song structure includes an ‘ABAB’ repetition type, the stitched pattern ‘AB’ instead of ‘ABAB’ would be processed by the music generator 62 to generate pitches. To deal with anacrusis in generating a MIDI file, the music generator 62 may pad the first chord to an extra bar at the beginning of the song, and not merge any pickup bars. Following pitch generation, the generated music file 84 may be chopped into 4-bar or 5-bar pieces, for example.

The outputted music file 84 may be in a format which carries information about the melody, rhythm pattern, etc. of the song. One example is the MIDI format which carries musical information about the pitch, start timing, stop timing, loudness (attack velocity), etc. The MIDI data can be multi-track, and each track can have a musical instrument type associated with it, such as piano, bass guitar, strings, and drums. In this way, the melody can be encoded in one track of a multi-track MIDI file the rhythm can be another track of the MIDI file, etc. The MIDI file may be played through a playback program that assigns synthesized and/or sampled electronic instruments to playback each track, thereby generating an audio file of the song. In one example, the MIDI file may have a General MIDI format, so that like sounding instruments are assigned to predetermined MIDI instrument codes.

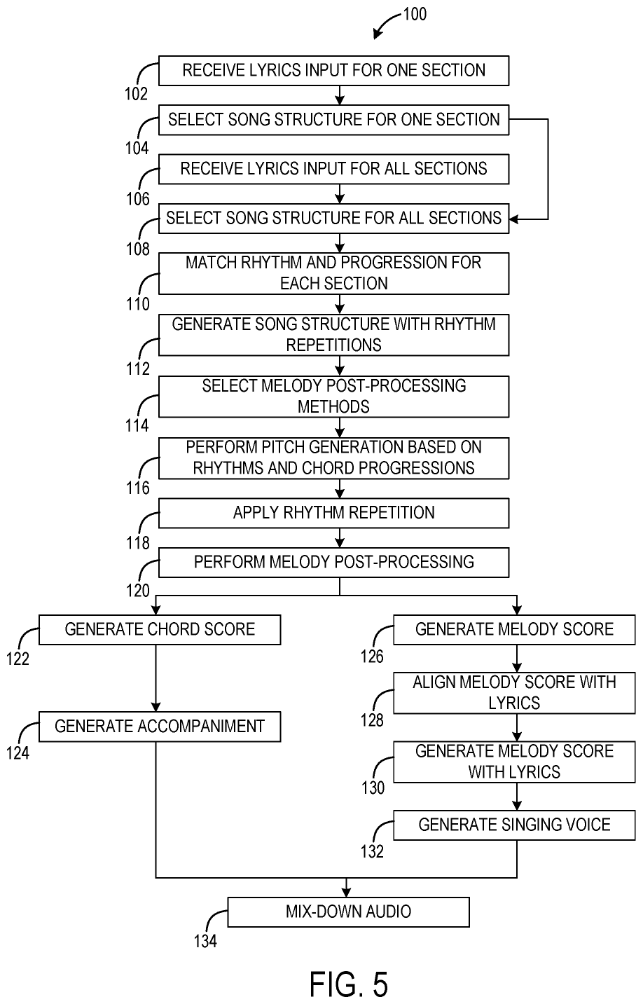

FIG. 5 illustrates a flow chart of an exemplary method 100 for generating music from an input of lyrics. The following description of method 100 is provided with reference to the software and hardware components described above and shown in FIGS. 1-4. It will be appreciated that method 100 also may be performed in other contexts using other suitable hardware and software components.

The method 100 may start at step 102, when user input of lyrics for one song section is received. After step 102, a song structure is selected at step 104 for the one song section that is specified by the user input of lyrics. After step 104, the music generation program generates the rest of the song sections and selects the song structure for the rest of the song sections at step 106.

Alternatively, the method 100 may start at step 106, when a user or a machine inputs lyrics for all song sections. At step 108, song structures are selected for all song sections in accordance with the inputted lyrics, parsing the lyrics to obtain phonemes, group the phonemes by syllables.

The method 100 continues to step 110, at which a rhythm template and a chord progression template are matched for each song section. At step 112, a song structure with rhythm repetitions is generated. At step 114, melody post-processing methods are selected. At step 116, inputting the populated score template into the music generator, pitch generation is performed based on the rhythms and chord progressions specified in the score template. At step 118, rhythm repetition is applied in accordance with the score template. At step 120, the melody post-processing methods selected in the score template are performed.

At step 122, a chord score is generated, and at step 124, accompaniment is generated. At the same time as steps 122 and 124, at step 126, the melody score is generated. At step 128, the melody score is aligned with the lyrics. At step 130, a melody score with the lyrics is generated. At step 132, a singing voice is generated. At step 134, a mix-down audio is generated based on the generated chord score and melody score.

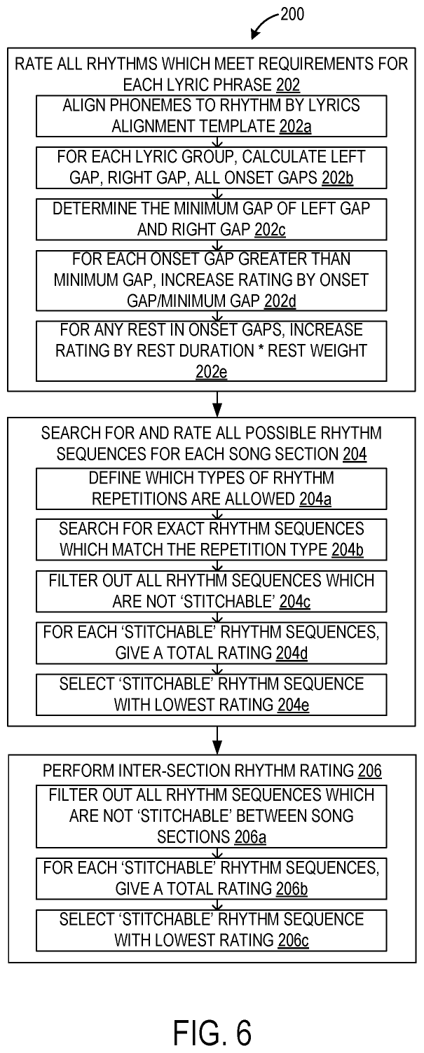

FIG. 6 illustrates a flow chart of an exemplary method 200 for assigning rhythm templates to song sections and generating a song structure of rhythm repetitions. The following description of method 200 is provided with reference to the software and hardware components described above and shown in FIGS. 1-4. It will be appreciated that method 200 also may be performed in other contexts using other suitable hardware and software components.

The method 200 comprises three main steps: step 202 in which all rhythms which meet the requirements for each lyric phrase are rated, step 204 in which all possible rhythm sequences for each song section are searched for and rated, and step 206 in which inter-section rhythm rating is performed.

Step 202, in which all rhythms which meet the requirements for each lyric phrase are rated, may include the following steps, and may be performed by the rhythm template selector. At step 202a, phonemes of the lyrics are aligned to the rhythm of the rhythm template by the lyrics alignment template. At step 202b, for each lyric group, a left gap (the onset gap between the onset of the last lyric in the previous lyric group and the onset of the first lyric in the current lyric group), a right gap (the duration of the last lyric), and all onset gaps in the current lyric group are calculated.

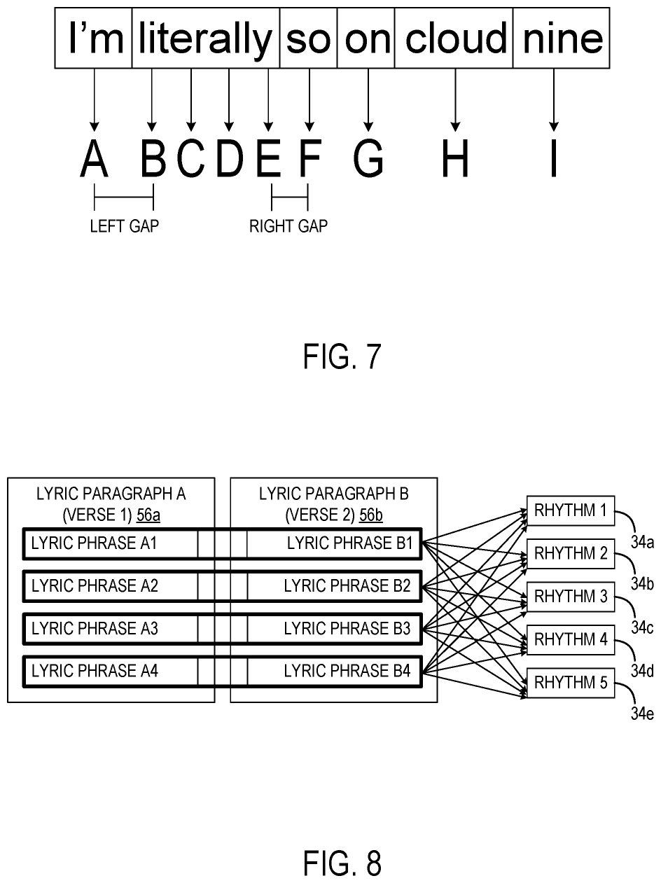

Referring to FIG. 7, the process for determining the left gap and the right gap for an exemplary lyric phrase is illustrated. The lyric phrase ‘I'm literally so on cloud nine’ is aligned with the syllables A to I of a rhythm template. The lyric group ‘literally’ is aligned with the syllables BCDE of the rhythm template. Here, the left gap is the duration gap between the onset of note A and the onset of note B, and the right gap is the duration of the note E.

Referring to FIG. 8, an example is depicted of the process of rating rhythm templates in cases in which there are multiple variations for a given lyric phrase in a song section. In this example, there are three variations A2, A3, A4 for the first lyric phrase Al of the first verse pattern 56a, and three variations B2, B3, B4 for the second lyric phrase B1 of the second verse pattern 56b. In this case, lyric phrases that share the same position are used together to rate the rhythm templates. In the example of FIG. 8, the first lyric phrase Al (main phrase) is used together with the second lyric phrase B1 (main phrase), the first lyric phrase A2 (first variation) is used together with the second lyric phrase B2 (first variation), the first lyric phrase A3 (second variation) is used together with the second lyric phrase B3 (second variation), and the first lyric phrase A4 (third variation) is used with second lyric phrase B4 (third variation) to assign ratings for the two lyric phrases in adjacent verses which are to be linked together in a rhythm sequence. Here, lyric phrase pair A1-B1, lyric phrase pair A2-B2, lyric phrase pair A3-B3, and lyric phrase pair A4-B4 are rated against the first rhythm template 34a, the second rhythm template 34b, the third rhythm template 34c, the fourth rhythm template 34d, and the fifth rhythm template 34e.

Returning to FIG. 6, at step 202c, the minimum gap of the left gap and the right gap is determined. For example, if the left gap is smaller than the right gap, then the left gap is determined as the minimum gap. If the right gap is smaller than the left gap, then the right gap is determined as the minimum gap.

At step 202d, for each onset gap which is greater than the minimum, the rating is increased by onset gap/minimum gap. In pseudocode, this rating increase would be represented by the equation: rating=rating+g/m, where g is each onset gap and m is the minimum gap. At step 202e, for any rest, or a music bar with no notes, in each onset gap, the rating is increased by the product of the rest duration and the rest weight. In pseudocode, this rating increase would be represented by the equation: rating=rating+rest duration*rest weight.

Step 204, in which all possible rhythm sequences for each song section are searched for and rated, may include the following steps, and may be performed by the repetition constructor. At step 204a, the types of rhythm repetitions which are allowed are defined. For example, for two lyric phrases, AA and AB rhythm repetitions may be allowed. For four lyric phrases, AAAA, AABA, ABAB, AABB, ABCB, ABAC, AABC, and ABCC rhythm repetitions may be allowed. At step 204b, for each repetition type, the exact rhythm sequences that match the repetition type are searched for. For example, for rhythm repetition ABAB, rhythm sequences [rhythm 1, rhythm 3, rhythm 1, rhythm 3] and [rhythm 1, rhythm 4, rhythm 1, rhythm 4] may be selected.

At step 204c, all rhythm sequences which are not ‘stitchable’, or not appropriate to link together in rhythm sequences, are filtered out. For example, if the next rhythm template has anacrusis (pickup notes) and the current rhythm template does not have enough space at the end to accommodate the anacrusis, the two rhythms are not ‘stitchable’. At step 204d, a total rating is given for each ‘stitchable’ rhythm sequence by adding the rating of each rhythm template multiplied by a weight, which is the number of repetitive rhythms in this sequence. For example, for the rhythm sequence [rhythm 1, rhythm 4, rhythm 1, rhythm 4] , the total rating will be (0.1+0.2+0.3+0.6)*2=2.4. The weighting mechanism makes the method 200 more likely to select more repetitive rhythm sequences due to the lower weight. At 204e, the ‘stitchable’ rhythm sequence with the lowest rating is selected as the rhythm sequence to use for the song section.

Step 206, in which the inter-section rhythm rating is performed, the ‘stitchability’ between those rhythm sequences that were selected in step 204 is evaluated, and may include the following steps, which may be performed by the repetition constructor. At step 206a, all of the rhythm sequences that are not ‘stitchable’ between song sections are filtered out. At step 206b, for all the ‘stitchable’ rhythm sequences, total ratings are given by summing up all the ratings in the rhythm sequence. At step 206c, the ‘stitchable’ rhythm sequence with the lowest rating is selected as the rhythm sequence between song sections.

The above-described system and methods generate lyric-aligned melodies from lyrics, which may lower the barrier to music composition for users. Generated melodies accommodate varied song structures including verses and choruses, as well as rhythm and song section repetitions. Lyrics are aligned to melodies by drawing from different rhythm templates and chord progression templates, increasing the variety of possible melody compositions. By lowering the barrier to music composition, user engagement may be increased on social platforms hosting the music generation program. Amateurs and professional musicians alike may benefit from using an easy-to-use music creation tool to create songs from lyrics.

In some embodiments, the methods and processes described herein may be tied to a computing system of one or more computing devices. In particular, such methods and processes may be implemented as a computer-application program or service, an application-programming interface (API), a library, and/or other computer-program product.

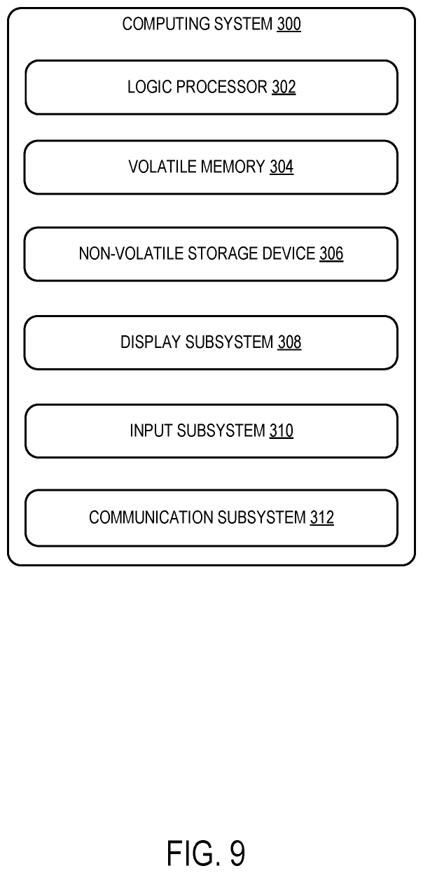

FIG. 9 schematically shows a non-limiting embodiment of a computing system 300 that can enact one or more of the methods and processes described above. Computing system 300 is shown in simplified form. Computing system 300 may embody the music generation computing device 12 or client computing device 64 described above and illustrated in FIG. 1, respectively. Computing system 300 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 300 includes a logic processor 302 volatile memory 304, and a non-volatile storage device 306. Computing system 300 may optionally include a display sub system 308, input sub system 310, communication sub system 312, and/or other components not shown in FIG. 9.

Logic processor 302 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 302 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 306 includes one or more physical devices configured to hold instructions executable by the logic processors to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by logic processor 302 to temporarily store information during processing of software instructions. It will be appreciated that volatile memory 304 typically does not continue to store instructions when power is cut to the volatile memory 304.

Aspects of logic processor 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via logic processor 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with logic processor 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 300 to send and/or receive messages to and/or from other devices via a network such as the Internet.

The following paragraphs provide additional support for the claims of the subject application. One aspect provides a music generation system comprising a processor and a memory operatively coupled to the processor and storing a rhythm template database comprising a plurality of rhythm templates; and a music generation program stored in the memory and executed by the processor to be configured to receive a user input of lyrics; identify a plurality of syllables in the lyrics; determine a syllable pattern in the identified plurality of syllables; match the syllable pattern to a selected rhythm template of the plurality of rhythm templates; generate a melody based on the selected rhythm template; generate a music file encoding the melody and the lyrics; and output the music file encoding the melody and the lyrics. In this aspect, additionally or alternatively, the outputted music file is a melody score with lyrics, a MIDI file with chord progressions, or an audio file. In this aspect, additionally or alternatively, the lyrics comprise a plurality of song sections; the selected rhythm template is matched to the syllable pattern of one of the plurality of song sections; and each of the plurality of song sections is matched to one of the plurality of rhythm templates. In this aspect, additionally or alternatively, the user input of lyrics comprises song structure settings including a song structure; and the melody is generated based on the song structure indicating an order of the plurality of song sections. In this aspect, additionally or alternatively, each of the plurality of song sections is matched to one of the plurality of rhythm templates based on a list of allowed rhythm repetition types. In this aspect, additionally or alternatively, each of the plurality of song sections is matched to one of the plurality of rhythm templates based on a list of rhythms pairs that are prohibited from being linked with each other. In this aspect, additionally or alternatively, to match the syllable pattern to the selected rhythm template, a degree of matching between the syllable pattern and each of the plurality of rhythm templates is determined based on a number of syllables in the syllable pattern and a minimum number of syllables supported by each of the plurality of rhythm templates. In this aspect, additionally or alternatively, to match the syllable pattern to the selected rhythm template, a degree of matching between the syllable pattern and each of the plurality of rhythm templates is determined based on a number of syllable groups that require adding or subtracting to the determined syllable pattern to match with the selected rhythm pattern. In this aspect, additionally or alternatively, the memory is configured to further store a chord progression database comprising a plurality of chord progressions; the syllable pattern is matched to a selected chord progression of the plurality of chord progressions; and the melody is generated based on the selected rhythm template and the selected chord progression. In this aspect, additionally or alternatively, the melody is generated by performing pitch generation based on the selected rhythm template and the selected chord progression.

Another aspect provides a music generation method comprising steps to receive a user input of lyrics; identify a plurality of syllables in the lyrics; determine a syllable pattern in the identified plurality of syllables; match the syllable pattern to a selected rhythm template of the plurality of rhythm templates; generate a melody based on the selected rhythm template; generate a music file encoding the melody and the lyrics; and output the music file encoding the melody and the lyrics. In this aspect, additionally or alternatively, the outputted music file is a melody score with lyrics, a MIDI file with chord progressions, or an audio file. In this aspect, additionally or alternatively, the lyrics comprise a plurality of song sections; the selected rhythm template is matched to the syllable pattern of one of the plurality of song sections; and each of the plurality of song sections is matched to one of the plurality of rhythm templates. In this aspect, additionally or alternatively, the user input of lyrics comprises song structure settings including a song structure; and the melody is generated based on the song structure indicating an order the plurality of song sections. In this aspect, additionally or alternatively, each of the plurality of song sections is matched to one of the plurality of rhythm templates based on a list of allowed rhythm repetition types. In this aspect, additionally or alternatively, each of the plurality of song sections is matched to one of the plurality of rhythm templates based on a list of rhythms pairs that are prohibited from being linked with each other. In this aspect, additionally or alternatively, to match the syllable pattern to the selected rhythm template, a degree of matching between the syllable pattern and each of the plurality of rhythm templates is determined based on a number of syllable groups that require adding or subtracting to the determined syllable pattern to match with the selected rhythm pattern. In this aspect, additionally or alternatively, the syllable pattern is matched to a selected chord progression of a plurality of chord progressions; and the melody is generated based on the selected rhythm template and the selected chord progression. In this aspect, additionally or alternatively, the melody is generated by performing pitch generation based on the selected rhythm template and the selected chord progression.

Another aspect provides a music generation system comprising a processor and a memory operatively coupled to the processor and storing a rhythm template database comprising a plurality of rhythm templates and a chord progression database comprising a plurality of chord progressions; an audio reproduction device operatively coupled to the memory and the processor; and a music generation program stored in the memory and executed by the processor to be configured to receive a user input of lyrics; identify a plurality of syllables in the lyrics; determine a syllable pattern in the identified plurality of syllables; match the syllable pattern to a selected rhythm template of the plurality of rhythm templates; match the syllable pattern to a selected chord progression of the plurality of chord progressions; and generate a melody based on the selected rhythm template and the selected chord progression; generate an audio file or a MIDI file encoding the melody and the lyrics; and output the audio file or the MIDI file encoding the melody and the lyrics on the audio reproduction device.

It will be appreciated that “and/or” as used herein refers to the logical disjunction operation, and thus A and/or B has the following truth table.

| A | B | A and/or B |
|---|---|---|
| T | T | T |
| T | F | T |
| F | T | T |
| F | F | F |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

To the extent that terms “includes,” “including,” “has,” “contains,” and variants thereof are used herein, such terms are intended to be inclusive in a manner similar to the term “comprises” as an open transition word without precluding any additional or other elements.

1. A music generation system comprising:
a processor and a memory operatively coupled to the processor and storing a rhythm template database comprising a plurality of rhythm templates; and
a music generation program stored in the memory and executed by the processor to be configured to:
receive a user input of lyrics;
identify a plurality of syllables in the lyrics;
determine a syllable pattern in the identified plurality of syllables;
match the syllable pattern to a selected rhythm template of the plurality of rhythm templates;
generate a melody based on the selected rhythm template;
generate a music file encoding the melody and the lyrics; and
output the music file encoding the melody and the lyrics.

2. The music generation system of claim 1, wherein the outputted music file is a melody score with lyrics, a MIDI file with chord progressions, or an audio file.

3. The music generation system of claim 1, wherein
the lyrics comprise a plurality of song sections;
the selected rhythm template is matched to the syllable pattern of one of the plurality of song sections; and
each of the plurality of song sections is matched to one of the plurality of rhythm templates.

4. The music generation system of claim 3, wherein
the user input of lyrics comprises song structure settings including a song structure; and
the melody is generated based on the song structure indicating an order of the plurality of song sections.

5. The music generation system of claim 3, wherein each of the plurality of song sections is matched to one of the plurality of rhythm templates based on a list of allowed rhythm repetition types.

6. The music generation system of claim 3, wherein each of the plurality of song sections is matched to one of the plurality of rhythm templates based on a list of rhythms pairs that are prohibited from being linked with each other.

7. The music generation system of claim 1, wherein, to match the syllable pattern to the selected rhythm template, a degree of matching between the syllable pattern and each of the plurality of rhythm templates is determined based on a number of syllables in the syllable pattern and a minimum number of syllables supported by each of the plurality of rhythm templates.

8. The music generation system of claim 1, wherein, to match the syllable pattern to the selected rhythm template, a degree of matching between the syllable pattern and each of the plurality of rhythm templates is determined based on a number of syllable groups that require adding or subtracting to the determined syllable pattern to match with the selected rhythm pattern.

9. The music generation system of claim 1, wherein
the memory is configured to further store a chord progression database comprising a plurality of chord progressions;
the syllable pattern is matched to a selected chord progression of the plurality of chord progressions; and
the melody is generated based on the selected rhythm template and the selected chord progression.

10. The music generation system of claim 1, wherein the melody is generated by performing pitch generation based on the selected rhythm template and the selected chord progression.

11. A music generation method comprising steps to:
receive a user input of lyrics;
identify a plurality of syllables in the lyrics;
determine a syllable pattern in the identified plurality of syllables;
match the syllable pattern to a selected rhythm template of the plurality of rhythm templates;
generate a melody based on the selected rhythm template;
generate a music file encoding the melody and the lyrics; and
output the music file encoding the melody and the lyrics.

12. The music generation method of claim 11, wherein the outputted music file is a melody score with lyrics, a MIDI file with chord progressions, or an audio file.

13. The music generation method of claim 11, wherein
the lyrics comprise a plurality of song sections;
the selected rhythm template is matched to the syllable pattern of one of the plurality of song sections; and
each of the plurality of song sections is matched to one of the plurality of rhythm templates.

14. The music generation method of claim 13, wherein
the user input of lyrics comprises song structure settings including a song structure; and
the melody is generated based on the song structure indicating an order the plurality of song sections.

15. The music generation method of claim 13, wherein each of the plurality of song sections is matched to one of the plurality of rhythm templates based on a list of allowed rhythm repetition types.

16. The music generation method of claim 13, wherein each of the plurality of song sections is matched to one of the plurality of rhythm templates based on a list of rhythms pairs that are prohibited from being linked with each other.

17. The music generation method of claim 11, wherein, to match the syllable pattern to the selected rhythm template, a degree of matching between the syllable pattern and each of the plurality of rhythm templates is determined based on a number of syllable groups that require adding or subtracting to the determined syllable pattern to match with the selected rhythm pattern.

18. The music generation method of claim 11, wherein
the syllable pattern is matched to a selected chord progression of a plurality of chord progressions; and
the melody is generated based on the selected rhythm template and the selected chord progression.

19. The music generation method of claim 11, wherein the melody is generated by performing pitch generation based on the selected rhythm template and the selected chord progression.

20. A music generation system comprising:
a processor and a memory operatively coupled to the processor and storing a rhythm template database comprising a plurality of rhythm templates and a chord progression database comprising a plurality of chord progressions;
an audio reproduction device operatively coupled to the memory and the processor; and
a music generation program stored in the memory and executed by the processor to be configured to:
receive a user input of lyrics;
identify a plurality of syllables in the lyrics;
determine a syllable pattern in the identified plurality of syllables;
match the syllable pattern to a selected rhythm template of the plurality of rhythm templates;
match the syllable pattern to a selected chord progression of the plurality of chord progressions;
generate a melody based on the selected rhythm template and the selected chord progression;
generate an audio file or a MIDI file encoding the melody and the lyrics; and
output the audio file or the MIDI file encoding the melody and the lyrics on the audio reproduction device.
